(19) United States
(12) Patent Application Publication
(10) Pub. No.: US 2008/0226874 A1
(43) Pub. Date: Sep. 18, 2008

(54) METHOD FOR FINISHING A WOOD MATERIAL BOARD

(75) Inventor: Norbert Kalwa, Horn-Bad Meinberg (DE)

Correspondence Address: GREENBLUM & BERNSTEIN, P.L.C., 1950 ROLAND CLARKE PLACE, RESTON, VA, 20191, US

(73) Assignee: FLOORING TECHNOLOGIES LTD., Malta

(21) Appl. No.: 12/037,367

(22) Filed: Feb. 26, 2008

(30) Foreign Application Priority Data
Mar. 12, 2007 (DE) 10 2007 012 236.7

(51) Int. Cl. B32B 3/10; B29C 39/12

(52) U.S. Cl. 428/156; 264/485

(57) ABSTRACT

A revised Abstract is attached hereto. The Abstract attached hereto should replace the original Abstract.

### CROSS REFERENCE TO RELATED APPLICATIONS

The present application claims priority under 35 U.S.C. §119 to German Patent Application No. 10 2007 012 236.7, filed on Mar. 12, 2007, the contents of which are incorporated in their entirety herein by reference.

The invention relates to a method for finishing a wood material board, e.g., an MDF or an HDF board.

From WO 2005/010296 a laminate flooring with an underside supporting board is known, which has a tongue/groove connection on at least one pair of opposite edges, and which is provided with a top-side use and wear layer, to which a decorative layer provided between the supporting board and the use and wear layer adjoins on the underside. In order to give the laminate flooring a boarded floor appearance regardless of the width and length of the supporting board, an indentation is provided on the top side extending between two opposite sides and aligned parallel to a pair of opposite sides, over which indentation the decorative layer as well as the use and wear layer extend.

The decorative layer can be printed. Varnishes that are curable by high-energy electron beams (EBH varnishes) or UV varnishes with a comparatively slightly crosslinked structure are often used for varnishing or for sealing wood and wood material boards in order to obtain high-gloss surfaces.

Structurants are used to obtain structures in the surface. These are varnished and structured papers that are used as a matrix for surface structures. They are used during the actual varnishing process. These structurants make it possible to produce only relatively flat and lightly structured surfaces. Producing sharp-edged and/or deep structures is not possible.

It is also known to use chemicals that influence the flow of the varnishes in a targeted manner, thus generating structures through targeted flow disturbances. This method is reduced to products to which the corresponding agents have been previously applied in a separate step. The method is limited to products to which small quantities of varnish are applied. This technology cannot be used in the case of products with high mechanical stress, such as, e.g., floors.

The object of the invention is to finish the surface of a wood material board, which can be, e.g., subsequently processed for flooring panels or used as a furniture board. The object is attained with the following steps:

a) Applying a decorative layer to the top side,

b) Applying a sealing varnish layer onto the decorative layer,

c) Complete curing of the varnish layer by means of electron beams and

d) Embossing a structure into the varnish layer.

The structuring is carried out in-line or off-line with an embossing calender or a cycle press with the application of temperature and pressure. The temperature is in the range of 80 to 150° C. and the pressure is in a range of 15 to 40 bar. The temperature is preferably 100° C. and the pressure at 25 bar.

Depending on the layer thickness of the varnish and the embossing depth of the plate, structure depths of 50 to 250 μm, preferably 100 to 200 μm, can be obtained.

Press times in the single-digit second range can be realized in a stationary press. The surfaces predetermined by the matrices of the pressing plate or the calender roller can be imaged in the most precise manner.

A base layer, which is preferably a printed color layer, can be applied before the application of the decorative layer to the top side of the supporting board. The base layer can also be of paper. The decoration of the decorative layer is preferably a wood or stone reproduction.

A particularly natural visual impression of the finished wood material board is achieved if the structure embossed into the varnish layer corresponds to the grain of the wood decoration or to the veining of the stone reproduction.

The mechanical stress of the varnish film during embossing does not lead to a weakening of the bond or to any qualitative deterioration of the surface.

Instead of a wood decoration, a cork, leather, or tile appearance can be produced. The embossing of the structure can take place continuously or intermittently. The surface roughness is increased by the embossing. Visually attractive panels, in particular flooring panels, can be cut to size from the wood material board produced in this manner.

For example a wood material board was printed with a wood pattern by gravure printing. An electron beam-curable varnish was thereby used with wear-resistant and scratch-resistant additives, of which approx. 150 g/m² was applied. The varnish layer was completely cured with an electron beam with a dose rate of 60 kGray. A pressing plate into which a wood grain matching the pattern had been engraved, was placed on the upper side of the wood material board for 15 seconds at a temperature of 100° C. and a pressure of 35 bar. After the structuring, a gloss degree of 93 points (60°) was achieved, which was 88 points (60°) before the structuring (measurement according to EN ISO2813: Coating materials—determining the reflectometer value of coatings (apart from metal coatings) under 20°, 60° and 85° ((ISO2813: 1994, including Technical Correction 1: 1997)).

1. A method for finishing a wood material board comprising:
applying a decorative layer to a top side,
applying a sealing varnish layer onto the decorative layer,
completely curing of the varnish layer by use of electron beams, and
d) embossing a structure into the varnish layer.

2. The method according to claim 1, further comprising applying a base layer before the decorative layer is applied to the top side.

3. The method according to claim 2, wherein the base layer is a printed color layer.

4. The method according to claim 1, wherein the decorative layer simulates a natural pattern.

5. The method according to claim 4, wherein the pattern is a wood or stone reproduction.

6. The method according to claim 5, wherein the structure is embossed according to a wood grain of the wood pattern or the veining of the stone reproduction.

7. The method according to claim 1, wherein a surface of the varnish layer is high-gloss.

8. The method according to claim 1, wherein the embossing of the structure is carried out by use of a stamping plate.

9. The method according to claim 1, wherein the embossing of the structure is carried out with a roller.

10. The method according to claim 8, wherein the structure is embossed at a temperature of 80 to 150° C. and a pressure of 15 to 40 bar.

11. The method according to claim 10, wherein the temperature is 100° C.

12. The method according to claim 10, wherein the pressure is 25 bar.

13. The method according to claim 1, wherein the structure is embossed with a depth of 50 to 250 μm.

14. A panel comprising a wood material board produced according to claim 1.

15. The method of claim 1, wherein the structure is embossed with a depth of 100 to 200 μm.

16. The method according to claim 9, wherein the structure is embossed at a temperature of 80 to 150° C. and a pressure of 15 to 40 bar.
